(19) United States
(12) Patent Application Publication
(10) Pub. No.: US 2008/0139097 A1
(43) Pub. Date: Jun. 12, 2008

(54) Curved Asymmetrical Gambrel

(76) Inventor: John Smick, Rudolph, WI (US)

Correspondence Address: LANE PATENTS LLC, 100 NORTH 72ND AVE., SUITE 107, WAUSAU, WI, 54401, US

(21) Appl. No.: 11/944,691

(22) Filed: Nov. 26, 2007

Related U.S. Application Data
(63) Continuation-in-part of application No. 60/869,143, filed on Dec. 8, 2006.

(51) Int. Cl. A22B 5/06

(52) U.S. Cl. 452/189

(57) ABSTRACT

A curved gambrel with an asymmetrical design, having an incline end on one distal end and a hooked end on the other. The gambrel will hold a mass, for example, the hocks of the animal, on the incline end and hooked end for skinning and quartering. When the inclined mass is removed from the incline end, which is much easier than removing from a hook, the remaining hooked mass will hang securely from the hooked end.

### FIELD OF THE INVENTION

The present invention relates to a portable tool for hanging or dressing game, in particular, a gambrel for hanging, moving or dressing carcasses.

### BACKGROUND OF THE INVENTION

The use of gambrels is well known to butchers and to those who hunt, because a gambrel is used to lift, move or suspend a carcass for dressing, typically by affixing the gambrel through the legs of the game. Most gambrels consist of a simple cross piece with a high point in the middle for lowering the effective center of gravity to allow the hocks of the animal to hang in a balanced manner. A typical gambrel is suspended by a rope, tie, chain or other means, and used to separate the carcass' hocks to allow easy access for quartering. Once quartered, the legs are removed from the gambrel.

The prior art shows gambrels of symmetrical design. Many gambrel designs are inclined, having a slight incline at each distal end. While the inclined end allows a hunter to easily slide the first hock from the gambrel, this creates an unstable condition wherein the remaining section of carcass, without the counter balance of the first hock which has been removed, simply slides from the opposite inclined distal end.

Another symmetrical gambrel design, provides hooks at each distal end. By supplying a hook on both ends, the remaining carcass is held in place when the first hock is removed, as seen in U.S. Pat. No. 4,909,555 issued to Blasi, which discloses a gambrel with two hooks on either end, each having a knob to give a blunt end and further hold the meat in place. The problem with having hooks at each distal end is that it is much harder to secure the pre-sectioned carcass, which is many times quite heavy, onto the gambrel by navigating the curves of each hook. It requires much work to lift, navigate and remove the carcass from the end of the hook with the weight of a carcass on both ends.

U.S. Pat. No. 2,169,928 issued to Saley, discloses a collapsible gambrel with detachable cross member. The important feature is that the hooks for the hocks swing freely from the ends. This makes it harder to hoist the meat from the gambrel as the hooks are free to move with the meat.

U.S. Pat. No. 2,227,698 issued to Braun, discloses a collapsible beef tree, which is mounted on two distinct runners. The problem to be addressed is the sliding of the hocks together and the easy transfer of the meat from the hooks. The present invention is much simpler, while accomplishing a similar result.

U.S. Pat. No. 4,763,942 issued to Lyon, discloses a portable gambrel which utilizes loops to hold and suspend the legs of the animal. These can be dangerous as the fingers of the user can be trapped or pinched in the loops. It also requires the leg to be lifted to a point where the loop becomes slack.

U.S. Pat. No. 5,591,077 issued to Rowe, discloses a gambrel with a swinging hook which allows half the meat to be removed at a time without the other portion falling to the ground (see FIG. 4). It is still more difficult to remove the first portion of meat, which would require lifting and hefting as opposed to simply sliding off as disclosed in the invention.

U.S. Pat. No. 6,565,426 issued to Mayhew, discloses a release gambrel. This allows the quick release of both legs or hocks, but not one at a time. It is also a more complex structure with moving parts. The present invention is much simpler.

U.S. Pat. No. 6,729,666 issued to Mullis, discloses a combination hanging and dragging gambrel type hunting aid. The hooks can have their position adjusted from an inside to an outside orientation. Strictly as a gambrel, it is expected to work much as any other instances of the prior art.

U.S. Pat. No. 6,974,374 issued to Teinert, discloses a self adjusting gambrel, which spreads out to accommodate various sizes of animal. The disclosure does not show the feature of being able to hold the remaining portion of the meat after the first portion is removed.

### BRIEF SUMMARY OF THE INVENTION

The current invention consists of an asymmetrical device for a gambrel comprising an incline end on one side and a hooked end on the other. The gambrel will hold mass, typically the hocks, or hind quarters, of the animal on the incline end and the hooked end while skinning and quartering. The first hind quarter is removed from the incline end, which is much easier than removing from a hook, allowing the second hind quarter to securely hang from the hooked end. The current invention is made of a sturdy material; typically steel, to enable the suspension of heavy game.

It is therefore an advantage of the invention to provide an asymmetrical gambrel for hanging or balancing two masses, such as the hind quarters of a harvested animal.

It is another advantage of the invention to transport the harvested animal across the ground.

It is another advantage of the invention to suspend the harvested animal above the ground.

It is another advantage of the invention to provide a way to remove the first hind quarter with minimum effort.

It is another advantage of the invention to provide a way for the second hind quarter to hang securely after the first hind quarter has been removed.

It is another advantage of the invention to be made of a sturdy material to enable the suspension of heavy game.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a gambrel of the current invention;

FIG. 2 is a perspective view of a gambrel of the current invention in use;

FIG. 3 is a perspective view of a gambrel of the current invention in use further in the process.

### DESCRIPTION OF THE PREFERRED EMBODIMENT

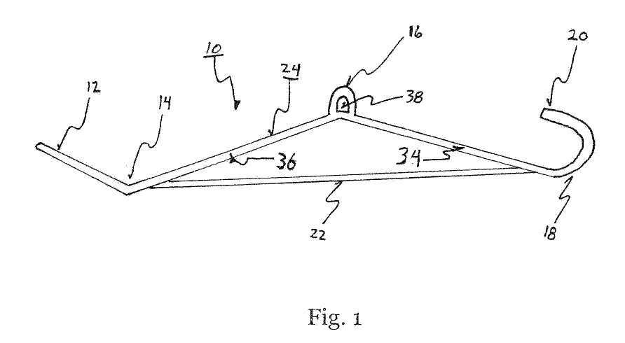

FIG. 1 discloses an embodiment of the preferred embodiment of the present invention. In this embodiment, the gambrel 10 consists of a frame member 24, made of steel or similar strong material, providing a fulcrum 16 near its peak, forming an obtuse angle between the hooked segment 34 and the incline segment 36. An inclined end 12 is formed at the distal end of the incline segment 36, forming an inclined rest 14 where the end 12 and segment 36 meet. A hooked end 18 is formed at the distal end of the hooked segment 34, forming a hooked rest 20 along the hooked end 18.

An enclosing member 40, made of steel or similar strong material, is connected between the hooked segment 34 and incline segment 36 of the frame member 24, forming an enclosure 38. A suspending device 26, which can be a rope, chain, cable, cord, strap or any other device used for suspending an item, maybe inserted through the enclosure 38, thereby allowing the gambrel 10 to be hung. The triangular shape of the enclosure 38 allows the suspending device 26 to slide along the frame member 24 or enclosing member 40 depending on the distribution of mass between the inclined end 12 and the hooked end 18. A suspension point 42 is defined as the point along the frame member 24 or enclosing member 40, at which the suspending device 26 exerts most of its upward force. A suspension axis 44 is formed between the suspension point 42 and the source of gravity.

The gambrel 10 is used to suspend a mass 28 using the inclined end 12 and hooked end 18. The inclined mass 30 is the part of the mass 28 inserted onto the inserted end 12. Hooked mass 32 is the part of the mass 28 inserted onto the hooked end 18. The inclined end 12 is used as a mounting point for the inclined mass 30, which, by gravity, slides to the position of the inclined rest 14 when the mass 28 is hoisted or moved. The hooked end 18 is used as a mounting point for the hooked mass 32, which, by gravity, slides to the position of the hooked rest 20 when the mass 28 is hoisted or moved.

The inclined end 12, as shown, is a straight piece of frame that angles toward the fulcrum 16, and the hooked end 18 is in the shape of an open hook facing upwards. In one method of use, the asymmetrical design of the gambrel 10 allows removal of the inclined mass 30, while keeping the hooked mass 32 attached to the hooked end 18.

Other embodiments may include various shapes and angles of the inclined end 12 or the hooked end 18. The inclined end 12 may be any segment or extension from the incline segment 36 where an axis parallel to the suspension axis 44 only crosses the inclined end 12 at one point along the inclined end 12 while the gambrel 10 is substantially balanced or at rest while suspended. The hooked end 18 may be any segment or extension from the incline segment 36 where an axis parallel to the suspension axis 44 crosses the hooked end 18 at more than one point along the hooked end 18 when the gambrel 10 is substantially balanced or at rest while suspended. Other embodiments can include a plurality of inclined ends 12 at the end of the incline segment 36 and a plurality of hooked ends 18 at the end of the hooked segment 34 consistent with the parameters and purposes described herein.

In the preferred embodiment as shown, a support member 22, made of steel or similar strong material, is connected between the hooked segment 34 and incline segment 36 of the frame member 24 for added support. The support member 22 is optional as needed.

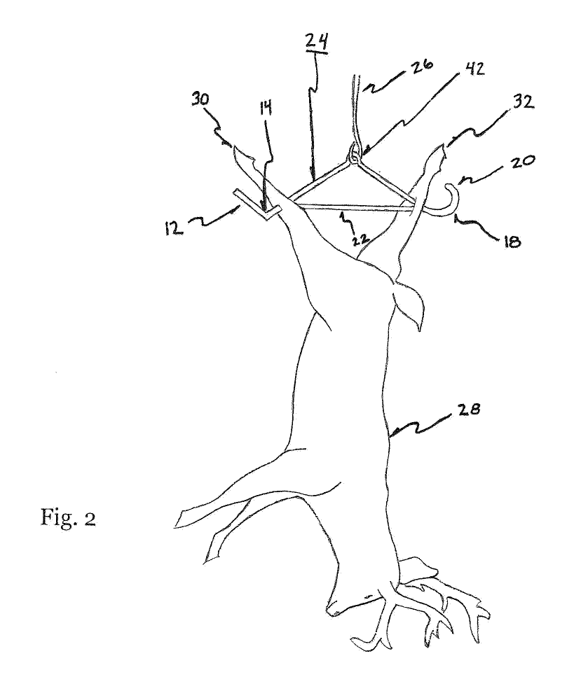

FIG. 2 shows how a mass 28, an animal carcass in particular, may be suspended using the gambrel 10. In one method of use, the inclined end 12 is inserted through a hock of the animal carcass. The hooked end 20 is inserted through another hock of the animal carcass. A suspending device 26 such as a rope, hook, cable or other similar device, is attached between a hoist and through the enclosure 38 and the animal carcass is lifted, hoisted, or moved into position for skinning or butchering. As butchering commences, sections of the carcass 28 are removed for further processing. This is generally referred to as quartering. This is best accomplished by removing the inclined mass 30 from the inclined rest 14 first by sliding it from the inclined end 12.

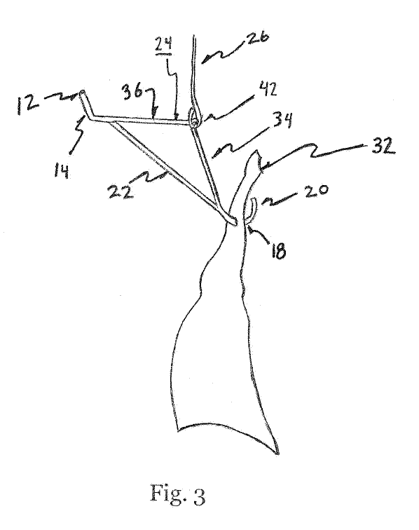

FIG. 3 shows how the weight of the hooked mass 32 is supported by the hooked rest 18, which rotates into place before or during the removal of the inclined mass 30. Without the hooked rest 18 attached to the hooked mass 32, the carcass would slide from the gambrel 10 to the ground, as the inclined mass 30 is being removed.

It is readily shown from the forgoing figures that the present invention is quite versatile as needed for the many situations found in the general harvest of animals on the field or farm. Mass, as used in this disclosure includes carcass, but may in some instances involve a live animal, depending on the circumstances.

For the purposes of illustration of the preferred embodiment in FIGS. 2 and 3, the term inclined mass 30 refers to a hock that is mounted on the inclined end 12 of the gambrel 10. The term hooked mass 32 refers to a hock that is mounted on the hooked end 20 of the gambrel 10. It should be obvious to those skilled in the art that either hock of a carcass can be used as a hooked mass 32 or inclined mass 30, and that the terminology for a mass as “inclined” and “hooked” are used to describe which end of the gambrel 10 each mass is interfaced.

The term “mass” can include any part of an object used to suspend it. Furthermore, it should be noted that those skilled in the art could appreciate alternative embodiments of the present invention that suspend masses and objects, including an animal carcass, for the purposes described herein. The preferred embodiment employs an obtuse angle between the incline segment 36 and the hooked segment 34, although those skilled in the art may appreciate other configurations of a frame member 24 that would allow the gambrel 10 to support, form or balance an inclined end 12 and a hooked end 14 as herein described.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

Having thus described the invention, what is desired to be protected by Letters Patent is presented in the subsequent appended claims.

What is claimed is:

1. A gambrel comprising:
a frame member forming a fulcrum at or near the center of said frame member, said fulcrum dividing said frame member into an incline segment and a hooked segment, said frame member further comprising an inclined end at the distal end of said incline segment, said frame member further comprising a hooked end at the distal end of said hooked segment.

2. The gambrel of claim 1, wherein said gambrel further comprises a support member, wherein said support member connects to said frame member between said incline segment and said hooked segment.

3. The gambrel of claim 2, wherein said gambrel further comprises an enclosing member, wherein said enclosing member connects to said frame member between said incline segment and said hooked segment, forming an enclosure.

4. The gambrel of claim 3, wherein said enclosure further comprises an area to suspend said gambrel with a rope, chain, hook or other suspending device, whereby a mass may be balanced or stabilized between said inclined end and said hooked end when said gambrel is suspended by said suspending device using said enclosure.

5. The gambrel of claim 3, wherein said enclosing member, said frame member and said support member are made of steel, or similar hard structural material.

6. A gambrel comprising:
a) a support member;
b) an enclosing member;
c) a frame member forming a fulcrum at or near the center of said frame member, said fulcrum dividing said frame member into an incline segment and a hooked segment wherein a fulcrum angle of a predetermined degree is formed between said hooked segment and said incline segment, said frame member further comprising an inclined end at the distal end of said incline segment, said frame member further comprising a hooked end at the distal end of said hooked segment.
wherein said support member connects to said frame member between said incline segment and said hooked segment,
wherein said enclosing member connects to said frame member between said incline segment and said hooked segment, forming an enclosure for said suspending device between said enclosing member and said frame member, forming an enclosure.
wherein said enclosure further comprises an area to suspend said gambrel with a rope, chain, hook or other suspending device, whereby a mass may be balanced or stabilized between said inclined end and said hooked end when said gambrel is suspended by said suspending device through said enclosure.

7. The gambrel of claim 6, wherein said enclosing member, said frame member and said support member are made of steel, or similar hard structural material.

8. A method of removing a mass from the gambrel of claim 1 comprising the steps of:
a) removing said inclined mass suspended by said inclined end, and
b) removing said hooked mass suspended by said hooked end;
whereby when said inclined mass is removed from said inclined end, said hooked mass remains secured to said gambrel by said hooked end.
